(19) United States
(12) Patent Application Publication
(10) Pub. No.: US 2025/0070202 A1
(43) Pub. Date: Feb. 27, 2025

(54) VOLTAGE BLEED DOWN DURING HYDROGEN FUEL CELL SHUTDOWN FOR MEMBRANE FAILURE DETECTION

(71) Applicant: HYZON MOTORS USA INC., Bolingbrook, IL (US)

(72) Inventors: Jixin Chen, Canton, MI (US); George He, Troy, MI (US)

(21) Appl. No.: 18/815,015

(22) Filed: Aug. 26, 2024

Related U.S. Application Data
(60) Provisional application No. 63/578,788, filed on Aug. 25, 2023.

(51) Int. Cl. H01M 8/04537; H01M 8/04228; H01M 8/04664; H01M 8/04858

(52) U.S. Cl. CPC H01M 8/04559; H01M 8/04228; H01M 8/04679; H01M 8/0494; H01M 2250/20

(57) ABSTRACT

The present disclosure includes a fuel cell system comprising a fuel cell stack with multiple fuel cells and a control system in communication with the stack. The control system features a cell voltage monitoring system that measures the voltage of each fuel cell in the stack. If the measured voltage of a fuel cell drops below a predetermined threshold, the monitoring system triggers a shutdown procedure. The voltage bleed down time measured during the shutdown procedure, in comparison to a predetermined and calibrated threshold, can be used to indicate a membrane failure that requires a replacement of fuel cell stack.

### CROSS-REFERENCE TO RELATED APPLICATIONS

This application claims the benefit of U.S. Provisional Application No. 63/578,788, filed on Aug. 25, 2023. The entire disclosure of the above application is incorporated herein by reference.

### FIELD

The present technology relates to ways of detecting a membrane failure during operation of a fuel cell in an automotive fuel cell system, including adaptations for detecting a membrane failure by recording a voltage bleed down time of the fuel cell.

### INTRODUCTION

This section provides background information related to the present disclosure which is not necessarily prior art.

Fuel cell electric vehicles (FCEV) include a fuel cell, sometimes in combination with another electrical power source such as a battery, to power an onboard electric motor. Fuel cells in vehicles can generate electricity using oxygen sourced from ambient air and hydrogen stored onboard the vehicle. Most fuel cell vehicles are classified as zero-emissions vehicles, emitting only water vapor and heat.

A fuel cell within an automotive fuel cell system (FCS) may include a negative electrode or anode and a positive electrode or cathode that surround a membrane to form a membrane electrode assembly. The membrane may be permeable to particular ions and may be referred to as a polymer-electrolyte membrane. Certain examples include a membrane permeable to protons, which may be referred to as a proton-exchange membrane. A fuel, such as hydrogen, may be fed to the anode, and air may be fed to the cathode. In a hydrogen fuel cell, a catalyst at the anode separates hydrogen molecules into protons and electrons, which take different paths to the cathode. The electrons go through an external circuit, creating a flow of electricity. The protons migrate through the membrane to the cathode, where they unite with oxygen and the electrons to produce water and heat.

Due to limited diagnostic techniques onboard of the FCS within a FCEV, there may be no exclusive indication of an electrolyte membrane failure from normal operation of a fuel cell stack in an FCS. The membrane is an important component of the fuel cell stack, and a failure of the membrane might conclude a lifetime of the stack. Additionally, continued use of the fuel cell or fuel cell stack after a membrane failure may allow hydrogen to leak through the membrane and become a safety concern. Therefore, a membrane failure may not be detected quickly but is highly needed.

Accordingly, there is a need for a way to detect a membrane defect or failure in a fuel cell stack of a fuel cell system.

### SUMMARY

In concordance with the instant disclosure, a method of detecting a membrane defect or failure in a fuel cell and/or a fuel cell stack of a fuel cell system, has been discovered. The present technology includes articles of manufacture, systems, and processes that relate to the detection and diagnosis of membrane failures in fuel cell systems, particularly for automotive applications, utilizing voltage bleed down characteristics to assess membrane integrity and ensure efficient and safe operation of fuel cells.

In certain embodiments, a fuel cell system includes a fuel cell stack composed of a plurality of fuel cells and a control system. The control system, which is in communication with the fuel cell stack, includes a cell voltage monitoring system. The control system is configured to measure the voltage of each fuel cell within the stack and to initiate a shutdown procedure if a measured voltage of one of the fuel cells falls below a predetermined voltage.

In certain embodiments, a method of detecting a fuel cell membrane failure in a fuel cell system includes measuring the cell voltage of a fuel cell within the system. If the cell voltage falls below a predefined value, indicative of a potential membrane failure, a shutdown procedure is initiated. During the shutdown procedure, the voltage bleed down time of the affected fuel cell is recorded. A fuel cell membrane failure is detected if the voltage bleed down time is less than a calibrated threshold, allowing for targeted maintenance and ensuring system integrity.

In certain embodiments, a method of detecting a fuel cell membrane failure in a fuel cell system includes providing a fuel cell system that includes a fuel cell stack with a plurality of fuel cells and a control system. The control system, equipped with a cell voltage monitoring system, is configured to measure the voltage of each fuel cell within the stack either intermittently at predefined intervals or continuously throughout the operation of the fuel cell system. If the cell voltage of any fuel cell falls below a predefined cell voltage value, a shutdown procedure is initiated. The shutdown procedure includes reducing and disabling the cathode supply of the affected fuel cell while maintaining the anode supply and a pressure differential. Concurrently, any electrical load connected to the fuel cell is disconnected. During this shutdown, the voltage bleed down time of the affected fuel cell is recorded, specifically from 0.8 V to 0.2 V. A fuel cell membrane failure is then detected if the voltage bleed down time is less than a calibrated threshold.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting a fuel cell system of the present disclosure.

FIGS. 2A and 2B are a flowchart illustrating a method of detecting a fuel cell membrane failure in an automotive fuel cell system, according to an embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the reliability and efficiency of fuel cell systems by enabling early detection of membrane failures and facilitating targeted maintenance. The present disclosure relates to a fuel cell system. The fuel cell system can be an energy conversion device that produces electricity through a chemical reaction between hydrogen and oxygen, without combustion.

An example fuel cell system can include several components: a fuel cell stack where the electrochemical reaction occurs, a system to supply hydrogen to the anode, and air or oxygen supplied to the cathode. Additionally, a cooling system is necessary to manage the heat produced during the reaction, and a control system can monitor and adjust operational variables such as temperature and pressure. A power conditioner can also be included to convert the direct current produced into alternating current if necessary, and to regulate voltage.

In operation, hydrogen gas can be introduced to the anode side of each fuel cell in the stack, while oxygen, often from ambient air, can be supplied to the cathode side. At the anode, hydrogen molecules are split into electrons and protons. The electrons travel through an external circuit to the cathode, creating an electric current, while the protons move through the electrolyte membrane to the cathode. At the cathode, electrons, protons, and oxygen combine to form water, which is expelled as a byproduct. The reaction also generates heat, which is managed by the cooling system to maintain the fuel cell stack at a safe operating temperature. Fuel cell systems can be used in various applications, including transportation in vehicles like cars and buses, stationary power generation for buildings, and portable power in remote or outdoor activities.

The fuel cell system can be a 200 kilowatts fuel cell system, as a non-limiting example. 200 kW fuel cell systems can generate at least 200 kilowatts of electrical power, which is suitable for high-demand applications such as powering large vehicles like buses and trucks or providing stationary power for buildings and industrial facilities. The 200 kW fuel cell system can include a relatively large fuel cell stack, which can include a greater number of individual cells or larger cells to accommodate the increased energy conversion necessary to achieve the 200 kW output.

The fuel cell system can include a control system. The control system can be configured to automate and optimize operation of the fuel cell stack and the ancillary components. The control system can monitor parameters such as cell voltage, temperature, and the flow rates of hydrogen and oxygen via a plurality of sensors. The control system can also be configured to exchange data between the fuel cell system and external systems like a central computer of a vehicle. The control system can be configured to adjust operational parameters. For example, the control system can modify the rates at which hydrogen and oxygen are supplied to the fuel cells, regulate the activity of the cooling system, and adjust the electrical output as necessary.

The control system can include a cell voltage monitor. The cell voltage monitor can be in communication with the fuel cell stack, and in particular embodiment, with each individual fuel cell of the fuel cell stack. The cell voltage monitor can also be in communication with the central processor or microcontroller of the control system. By tracking the voltage of individual cells within the fuel cell stack, the cell voltage can monitor provide data that the processor uses to assess the operational status and detect any irregularities or potential issues such as membrane degradation or electrical connectivity problems, as discussed in greater detail herein.

The fuel cell system of the present disclosure can be specifically configured to detect a membrane failure of a fuel cell within the fuel cell system. In a fuel cell system, the absence of specialized electrochemical diagnostic devices, such as potentiostats which are commonly used in laboratory settings, can pose a challenge in performing diagnostics like hydrogen (H₂) crossover measurements for membranes. Hydrogen crossover measurements are important for assessing the integrity and functionality of the fuel cell membrane. Furthermore, operational strategies for fuel cells often deliberately avoid maintaining the cells at open-circuit voltage (OCV) to enhance durability and prolong the life of the system.

The fuel cell system according to the present technology can utilize a voltage bleed down time of a fuel cell within a fuel cell system as an indicator of membrane degradation during a service time of the automotive fuel cell system. Voltage bleed down in the context of a fuel cell system refers to a process of monitoring how the voltage of a fuel cell decreases over time under specific conditions. The decrease in voltage can be used as a diagnostic tool to assess the health of the fuel cell membranes, particularly to detect any failures or degradation. In a fuel cell with a healthy membrane, this may be a slow process that allows a permeation driven H₂ crossover. However, where the membrane is degraded or failed, this process may be much faster, where an additional path, such as a convection is created. When compared to a beginning-of-life voltage bleed down, a shorter voltage bleed down time may indicate a membrane defect or membrane failure. Since a voltage bleed down of an individual fuel cell may be monitored by a cell voltage monitor, this diagnostic technique can simultaneously examine each individual cell membrane in a fuel cell stack.

The voltage bleed down time—the duration it takes for the voltage to drop from a defined higher voltage (e.g., 0.8 V) to a lower threshold (e.g., 0.2 V)—can be measured and compared against a calibrated threshold or baseline established from a healthy, properly functioning fuel cell. If the bleed down time is shorter than the threshold, it suggests a potential membrane defect or failure. The system of the present disclosure can be configured for the early detection of issues that could lead to reduced efficiency or hydrogen leaks.

The fuel cell system can utilize the cell voltage monitor can be used to monitor the cell voltages of the individual fuel cells of the fuel cell stack. If the monitored voltage falls below a predefined threshold, the control system of the fuel cell system can initiate a shutdown procedure. During this procedure, the supply of oxygen (or air) to the cathode can be reduced and eventually disabled, while maintaining the anode supply, which can include managing the hydrogen flow and maintaining a pressure differential between the anode and cathode. Concurrently, the electrical load connected to the fuel cell can be disconnected to ensure that the subsequent voltage bleed down measurement accurately reflects the internal state of the fuel cell without external influences.

The control system can monitor the time for the voltage to drop from a higher value, such as 0.8 V, to a lower value, such as 0.2 V. By comparing the recorded bleed down time against a calibrated threshold, which represents the expected duration for a healthy membrane, the control system can determine the condition of the membrane of each of the fuel cells. If the analysis shows that the bleed down time exceeds the calibrated threshold, indicating no membrane failure, the control system of the fuel cell system can continue towards a safe restart or return to normal operations. Conversely, if a failure is detected, further diagnostic actions and necessary repairs can be undertaken.

Initiation of the testing method for the fuel cell system can commence when certain abnormal behaviors are detected, suggesting potential issues within the fuel cell system. The abnormal behaviors can serve as indicators that further investigation may be beneficial to the fuel cell system. When unexpected voltage fluctuations are observed, where the cell voltages deviate significantly from normal levels, it may indicate potential problems such as membrane degradation or electrical connectivity issues. Similarly, a rapid drop in voltage under normal operating conditions can suggest a breach in the membrane, allowing for accelerated hydrogen crossover.

Additionally, an increase in hydrogen consumption that does not correspond to an increase in power output may signal inefficiencies within the fuel cell, possibly due to leaks or membrane issues. A decrease in power output, not linked to external factors, can also prompt a test to diagnose underlying causes, such as failing cells within the stack. Elevated operating temperatures can be another trigger for testing. Higher than normal temperatures might indicate internal resistance or other inefficiencies, potentially due to compromised membrane integrity. Visible signs of leakage or damage around the fuel cell stack, or unusual sounds like hissing, are clear indicators that testing may be necessary to identify and rectify issues.

The historical data obtained from voltage bleed down times can aid in implementing predictive maintenance strategies. By understanding a typical lifecycle and failure modes of fuel cell membranes, maintenance can be scheduled before critical failures occur, thus minimizing downtime and operational disruptions. Additionally, the historical data allows for adjustments in operational parameters to optimize performance and extend the lifespan of the fuel cells. For example, if data shows that voltage bleed down times are faster in hotter conditions, operational adjustments such as cooling system enhancements can be made to mitigate this effect.

The detection of membrane failures in the fuel cell systems can be enhanced through automation, leveraging software algorithms integrated directly within the control system of the fuel cell system. The fuel cell system can be configured to continuously monitor the voltage levels of each cell within the fuel cell stack. By employing algorithms that can detect and analyze patterns in voltage bleed down times, the fuel cell system can automatically identify deviations that may indicate a membrane failure. Once a potential issue is detected, the control system of the fuel cell system can initiate a predefined shutdown procedure autonomously. Automation not only speeds up the response time in certain situations but also supports continuous operation and monitoring, even in remote or unmanned environments. This capability is important for maintaining the reliability of fuel cell operations across various applications, from automotive to stationary power systems.

To effectively execute a shutdown procedure in response to detected membrane failures or other critical issues in a fuel cell system fuel cell system, several specific actions would need to be taken by the system. The actions can be configured to safely halt operations, minimize effects on the fuel cell, and prepare the fuel cell system for either a safe restart or maintenance. The actions performed by the control system of the fuel cell system can include gradually reducing and eventually cutting off the supply of oxygen (or air) to the cathode, maintaining the anode supply (hydrogen flow) at a controlled rate, and disconnecting the load to prevent any electrical draw from the fuel cell. Additionally, the fuel cell system can monitor and record the time it takes for the voltage to drop from a defined higher voltage to a lower threshold.

Further actions during the shutdown process can involve managing the cooling system to militate against overheating, implementing checks for hydrogen leaks, and logging all relevant data for further analysis. Pressure equalization steps can be taken to avoid stress on fuel cell components, and the system may need to be isolated to prevent damage to other connected systems. Finally, the system can be brought to a state where it can either be safely restarted after a thorough inspection or opened up for maintenance, ensuring all internal systems are at safe operational levels, such as temperature and pressure.

### Examples

Example embodiments of the present technology are provided with reference to the figures enclosed herewith.

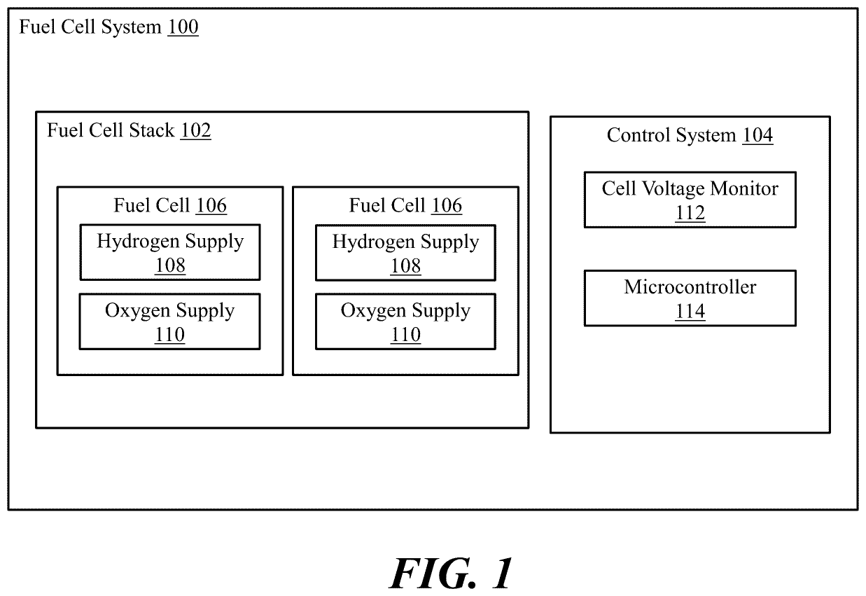

FIG. 1 is a graphical depiction of a fuel cell system 100 according to one embodiment of the present disclosure. The fuel cell system 100 can include a fuel cell stack 102 and a control system 104. The fuel cell stack 102 can include a plurality of fuel cells 106, a hydrogen supply system 108 that channels hydrogen to the anode side of the fuel cells 106 for a consistent and controlled flow for the electrochemical reactions, and an oxygen supply system 110 that provides oxygen, for example, drawn from ambient air to the cathode side of the fuel cells 106, supplying the necessary reactants for efficient electricity generation.

The control system 104 features a cell voltage monitoring system 114 that can continuously or intermittently assesses the voltage of each cell to detect any potential issues early, and a central processor or microcontroller 114 that utilizes data from the cell voltage monitor 112 to optimize performance and maintain system reliability. The control system 104 is particularly crucial for measuring the voltage bleed down time of each cell. The central processor or microcontroller 114 utilizes data from the cell voltage monitor 112 to optimize performance and maintain system reliability. Additionally, the control system 104 can modify the rates at which hydrogen and oxygen are supplied to the fuel cells 106. In response to detected anomalies, such as a rapid voltage drop that may indicate a membrane failure, the control system 104 can reduce and eventually disable the oxygen supply while maintaining the hydrogen flow as part of a broader shutdown procedure initiated by the control system 104.

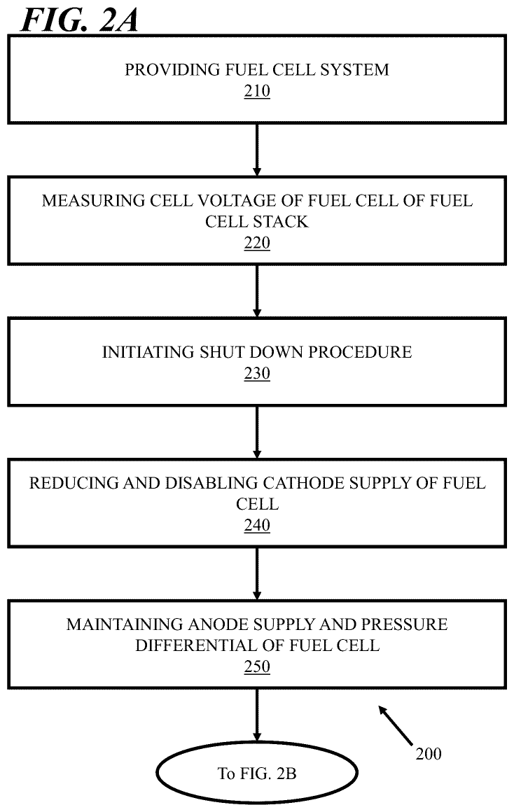

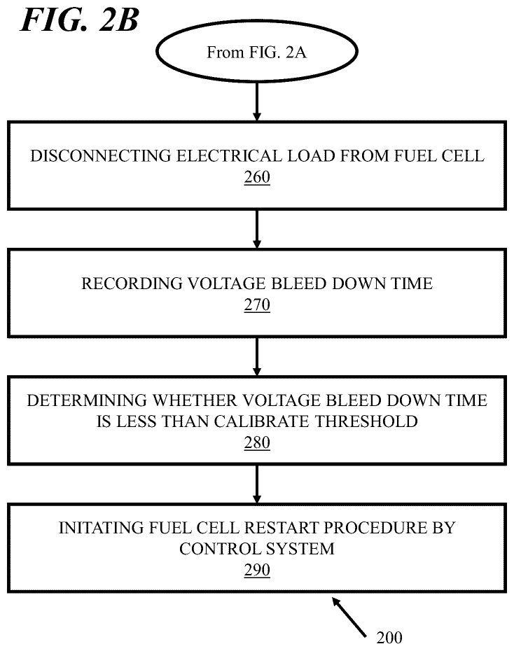

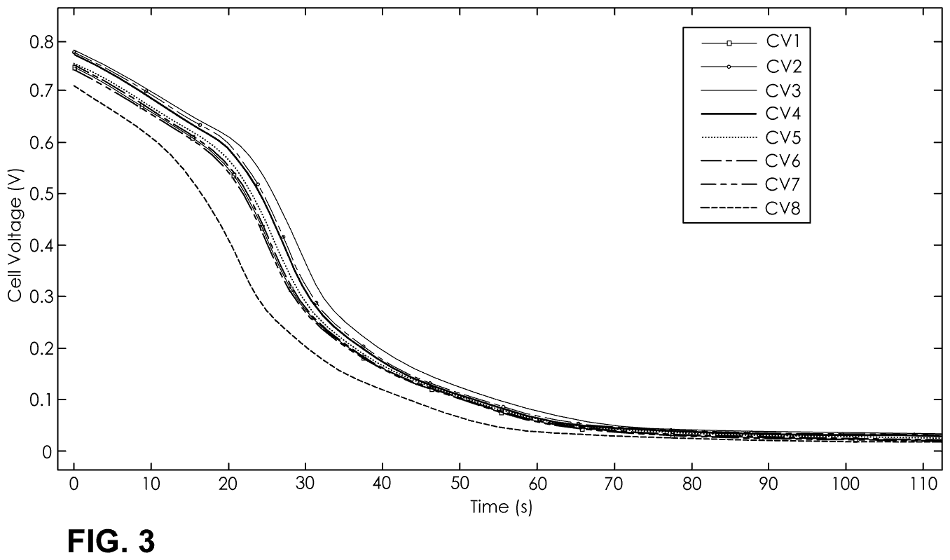

FIGS. 2A and 2B are a flowchart illustrating a method 200 of detecting a fuel cell membrane failure in a fuel cell system. At step 210, the method includes providing a fuel cell system including a fuel cell stack with a plurality of fuel cells and a control system equipped with a cell voltage monitoring system. At step 220, the cell voltage of each fuel cell within the fuel cell stack is measured, which can be done either intermittently at predefined intervals or continuously throughout the operation of the fuel cell system.

At step 230, a shutdown procedure is initiated if the cell voltage of any fuel cell falls below a pre-defined cell voltage value. At step 240, the method includes reducing and eventually disabling the cathode supply of the affected fuel cell. Concurrently, at step 250, the anode supply and a pressure differential of the fuel cell are maintained to stabilize the cell during the shutdown process.

At step 260, the electrical load connected to the fuel cell is disconnected. This isolation helps in accurately measuring the internal state of the fuel cell without external electrical interference. Following this, at step 270, the voltage bleed down time of the affected fuel cell is recorded, specifically from 0.8 V to 0.2 V.

At step 280, a determination is made whether the voltage bleed down time is less than a calibrated threshold, which would indicate a membrane failure. If the voltage bleed down time is greater than the calibrated threshold, indicating no membrane failure, the method proceeds to step 290 where the control system may automatically initiate a procedure to restart the fuel cell system. This comprehensive method ensures both the efficient operation and the reliability of the fuel cell system through continuous monitoring and responsive actions.

Example embodiments of the present technology described with reference to the following applications.

### Application 1: Automotive Fuel Cell System for Membrane Failure Detection

In an application within the automotive industry, the described fuel cell system, capable of generating 200 kilowatts of electrical power, utilizes its control system to enhance the reliability and safety of vehicles such as buses and trucks. The control system is equipped with a cell voltage monitor that continuously tracks the voltage of each individual cell within the fuel cell stack. This monitoring is crucial for detecting early signs of membrane failure, a common issue in fuel cell operations.

When the system identifies a voltage drop in any cell that falls below a predefined threshold, it automatically initiates a shutdown procedure. The shutdown procedure is important to militate against further damage and involves reducing the oxygen supply to the cathode, maintaining hydrogen flow to the anode, and disconnecting the electrical load. The system then records the voltage bleed down time, which is a diagnostic tool used to assess the health of the fuel cell membranes.

If the voltage bleed down time is significantly shorter than the baseline established for a healthy cell, it indicates a membrane failure. The system alerts the vehicle's control center and logs the incident for maintenance review. This proactive detection and response mechanism ensures that the vehicle can be serviced promptly, thereby maintaining operational efficiency and safety.

Application 2: Stationary Power Generation with Long-Term Fuel Cell Monitoring

In stationary power applications, such as those used in buildings and industrial facilities, the fuel cell system described can aid in ensuring uninterrupted power supply. The system includes a control system that not only manages operational parameters but also performs continuous health monitoring of the fuel cell stack. This is achieved through the cell voltage monitor, which assesses the voltage of each fuel cell against established baselines.

The ability to detect deviations in voltage bleed down times of the control system is particularly valuable. During routine checks, if the system observes that the voltage of any cell decreases from a defined higher voltage to a lower threshold more quickly than expected, it suggests potential membrane degradation. This early detection allows for targeted maintenance actions, such as replacing or repairing the affected cells, before they lead to larger system failures.

By implementing such a monitoring strategy, the facility can avoid unexpected downtimes and optimize the performance and lifespan of the fuel cell system. This application demonstrates how continuous monitoring, and automated diagnostics can significantly enhance the operational reliability and efficiency of stationary power systems.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A fuel cell system, comprising:
a fuel cell stack including a plurality of fuel cells; and
a control system, in communication with the fuel cell stack, the control system including a cell voltage monitoring system configured to measure the voltage of each fuel cell within the fuel cell stack and to initiate a shutdown procedure if a measured voltage of one of the fuel cells falls below a predetermined voltage indicative of a potential membrane failure.

2. The fuel cell system of claim 1, wherein the control system is configured to record a voltage bleed down time of an affected fuel cell during the shutdown procedure.

3. The fuel cell system of claim 2, wherein the control system is configured to monitor and record the voltage bleed down time from a defined higher voltage to a lower threshold.

4. The fuel cell of claim 3, wherein the voltage bleed down time is recorded from 0.8 V to 0.2 V for each cell.

5. The fuel cell system of claim 2, wherein the shutdown procedure includes reducing a supply of oxygen to a cathode of the affected fuel cell by the control system.

6. The fuel cell system of claim 2, wherein the shutdown procedure further includes maintaining a supply of hydrogen to an anode of the affected fuel cell by the control system.

7. The fuel cell system of claim 1, wherein the shutdown procedure further includes disconnecting an electrical load connected to the fuel cell stack by the control system.

8. The fuel cell system of claim 1, wherein the fuel cell stack is configured to generate at least 200 kilowatts of electrical power.

9. A vehicle comprising the fuel cell system of claim 1.

10. A method of detecting a fuel cell membrane failure in a fuel cell system comprising:
measuring a cell voltage of a fuel cell of the fuel cell system; and
initiating a shutdown procedure if the cell voltage is below a pre-defined cell voltage value; and
recording a voltage bleed down time of the fuel cell, wherein a fuel cell membrane failure is detected if the voltage bleed down time of the fuel cell is less than a calibrated threshold.

11. The method of claim 10, wherein the fuel cell system includes:
a fuel cell stack including a plurality of fuel cells; and
a control system, in communication with the fuel cell stack, the control system including a cell voltage monitoring system configured to measure the voltage of each fuel cell within the fuel cell stack and to initiate a shutdown procedure if a measured voltage of one of the fuel cells falls below a predetermined voltage indicative of a potential membrane failure.

12. The method of claim 11, wherein the step of initiating a shutdown procedure if the cell voltage value is below a pre-defined cell voltage value is performed automatically by the control system.

13. The method of claim 11, wherein the fuel cell stack is configured to generate at least 200 kilowatts of electrical power.

14. The method of claim 11, wherein the shutdown procedure includes:
reducing and disabling a cathode supply of the fuel cell;
maintaining an anode supply and a pressure differential of the fuel cell; and
disconnecting a load of the fuel cell.

15. The method of claim 11, wherein the control system of the fuel cell automatically initiates the shutdown procedure.

16. The method of claim 11, wherein if the measured voltage bleed down time is within the calibrated threshold indicating no membrane failure, the control system automatically initiates a procedure to restart the fuel cell system.

17. The method of claim 11, wherein the cell voltage of each fuel cell within the fuel cell stack is continuously monitored by the cell voltage monitoring system.

18. The method of claim 11, wherein the cell voltage of each fuel cell within the fuel cell stack is measured intermittently by the cell voltage monitoring system at predefined intervals.

19. The method of claim 10, wherein the voltage bleed down time is recorded from 0.8 V to 0.2 V for each fuel cell.

20. A method of detecting a fuel cell membrane failure in a fuel cell system comprising:
providing the fuel cell system including:
a fuel cell stack including a plurality of fuel cells; and
a control system, in communication with the fuel cell stack, the control system including a cell voltage monitoring system configured to measure the voltage of each fuel cell within the fuel cell stack
measuring a cell voltage of a fuel cell of the fuel cell stack, the cell voltage of each fuel cell within the fuel cell stack is measured intermittently by the cell voltage monitoring system at predefined intervals or continuously through operation of the fuel cell system;
initiating a shutdown procedure if the cell voltage is below a pre-defined cell voltage value, wherein the shutdown procedure includes:
reducing and disabling a cathode supply of the fuel cell;
maintaining an anode supply and a pressure differential of the fuel cell; and
disconnecting a load of the fuel cell; and
recording a voltage bleed down time of the fuel cell, wherein the voltage bleed down time is recorded from 0.8 V to 0.2 V for each fuel cell, wherein a fuel cell membrane failure is detected if the voltage bleed down time of the fuel cell is less than a calibrated threshold.
